(19) United States
(12) Patent Application Publication
(10) Pub. No.: US 2004/0059706 A1
(43) Pub. Date: Mar. 25, 2004

(54) System and method for providing concurrent usage and replacement of non-native language codes

(75) Inventor: Margaret A. Abelite, Morgan Hill, CA (US)

Correspondence Address: Samuel A. Kassatly, 6819 Trinidad Drive, San Jose, CA, 95120, US

(73) Assignee: International Business Machines Corporation, Armonk, NY

(21) Appl. No.: 10/255,347

(22) Filed: Sep. 25, 2002

(51) Int. Cl. G06F 7/00

(52) U.S. Cl. 707/1

(57) ABSTRACT

A computer program product is provided as a system and associated method, to provide concurrent usage and replacement of non-native language codes. The system creates a unique directory name when the non-native language initializes. The user ID associated with the process is the only user ID that has access to the process directory. This directory name is composed of a three-level hierarchy: the application environment name associated with the routine to be invoked; the database system name; and a unique system timestamp. The timestamp allows the present system to create a name for each non-native language process that can not be inadvertently duplicated. When the non-native language is invoked, the routine archive file is read to this directory. Since no other user ID can access this directory, the archive file is protected from damage or tampering. When the user modifies the non-native language's code, an external system command to refresh the application environment triggers the address space or process to terminate when currently executing work is completed. A new address space or process is started to take over any new work. On termination of the address space, the present system destroys the directory and all of its contents. Therefore, only the most recent version of the non-native language is maintained, minimizing required storage space and version conflicts.

### CROSS-REFERENCE TO RELATED APPLICATION

The present application relates to copending U.S. patent application Ser. No. ______, titled “System and Method for Creating a Restartable Non-Native Language Routine Execution Environment,” filed on even date herewith, which is assigned to the same assignee as the present application, and which is incorporated herein by reference.

### FIELD OF THE INVENTION

The present invention generally relates to database management systems, and particularly to a system and associated computer program device and method for creating a native runtime environment to execute non-native languages that operate on the information in the database management system. More specifically, this invention provides a method for storing non-native language process (or executable) codes in the database catalog; which codes are accessible only by a user ID that is unique to each process. In addition, a method is provided for allowing non-native language codes to be modified or edited and updated without causing outages or interrupting currently operating processes or executable codes.

### BACKGROUND OF THE INVENTION

Database systems are collections of files stored on computers or linked systems such as the Internet. The files together contain all the information about a topic or related topics. Generally, a file system is used to “file away” information which a user will later retrieve for processing.

Normally, a file resides in directly accessible storage and can be manipulated as a unit by file system operations. A file system allows a user the means for storing data in files, accessing the data in those files, managing direct access to storage space where the files are stored, and guaranteeing the integrity of those files. Businesses, e-businesses, and other organizations use databases to manage information about clients, orders, client accounts, etc.

Many businesses use databases to organize information and provide the ability to manipulate that information in a variety of ways. These databases are increasingly server-based databases, available for use by both employees and clients through the Internet. Large relational databases are used by companies to manage, for example, information about clients, orders, client accounts, etc., and by e-businesses to sell products or access to specialized information over the Internet.

To minimize the network transmission overhead time, the SQL workload performed against the database server should be server-based. These server-based workloads is primarily comprised of invocations of stored procedures and user-defined functions, written either entirely in SQL or in a fully-capable programming language such as C language, COBOL language, or Java®. When such routines are executed, they must perform in a fault-tolerant manner. This ensures that failures of the programs do not affect other database workloads or the execution of subsequent routines; essential availability of the database to clients or employees must not be compromised.

The current popularity of the Java programming language has naturally led to it being used to code database stored procedures and user-defined functions. The client, user, or employee accessing the database writes a user-defined function in Java to access and manipulate the data in the database through the network. This program may access the data many times which is time consuming for the user and resource consuming for the database. If there exist many users accessing the data in the database, the user-defined function may cause contentions against the data in the database.

For a database management system (“DBMS”), to execute such a Java or other non-native language, there must be available to the DBMS a virtual machine runtime in which to execute this routine. In addition, the ANSI specification for Java routines specifies that the byte codes to be executed must be able to be stored in a Java Archive (JAR) file in the database catalogue. Operating systems cannot execute routines stored in a database management system, therefore a method to provide the executable code to the operating system is needed. Therefore, what is needed is a method for storing and retrieving the executable codes, as well as a system that protects the files from inadvertent or intentional damage while they are stored externally in the file system.

On occasion, a user may wish to modify or update the Java routine's code. A method would then be needed for refreshing the executable codes being used by the database management system, without interrupting or affecting the performance of operating executable codes (or processes). In addition, updating, or modifying such routines should be done in a way that does not affect other database workloads or the execution of subsequent routines, without compromising the essential availability of the database to clients or users.

A possible solution would be to count the database usage. If no one is executing a process, database usage is halted while the code is updated. However, this causes the database to be unavailable to clients or employees while the process is being updated. It should be noted that database outages are costly to e-businesses and cumbersome to clients.

There is therefore a need for a system that provides unique, protected storage of the Java or other non-native language external to the database. In addition, the system should seamlessly refresh edited Java or other non-native languages without necessitating an outage of the database system for other executable codes. The need for such a system has heretofore remained unsatisfied.

### SUMMARY OF THE INVENTION

The present invention presents a system, a computer program product, and an associated method (collectively referred to herein as “the system” or “the present system”) for providing concurrent usage and replacement of normative language codes, that satisfy the foregoing need. The application of the present system is for any interpretive language that does not execute natively on an operating system. The routines operated by the present system can be written, for example, in various languages, including but not limited to: Java, C, Cobol, and so forth.

The present system creates a unique directory name when the normative language initializes. The user ID (or identification) associated with the process is the only user ID that has access to the directory. This directory name is composed of a three-level hierarchy.

The first level of the hierarchy is the workload manager operating system component WLM (application environment) name associated with the routine to be invoked. The second level is the database (i.e., DB2) subsystem name, since more than one database system can have access to the same file system. The third level of the directory name is a unique system timestamp, translated to characters. The timestamp represents a feature of the present system, which allows the present system to create a name for each non-native language process that can not be inadvertently duplicated.

When the non-native language is invoked, the archive file is read to this directory. Since no other user ID can access this directory, the archive file is protected from damage or tampering. One aspect of the present invention is that no work or task is postponed. If the non-native language code is changed, an external system command to refresh the application environment, causes any new work to be routed to a new process, while existing work or task in the existing processes is allowed to complete. The new process uses a new copy of the executable code that was replaced.

When all currently executing works are completed, the address space terminates. This approach allows for relatively higher availability of both the database and the execution environment used to execute the sever-based normative language executables. On termination of the address space, the present system destroys the directory and all of its contents. Therefore, only the most recent version of the non-native language is maintained, thus minimizing the required storage space and version conflicts.

Advantageously, the present system provides a robust support for e-business database solutions involving applications that exploit server-side normative languages inside a database engine.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which a system for concurrent usage and replacement of normative language codes of the present invention can be used;

FIG. 2 is a more detailed illustration of an example showing a plurality of systems for concurrent usage and replacement of non-native language codes of FIG. 1, being used in conjunction with a database management system;

FIG. 3 is a block diagram of the system for concurrent usage and replacement of non-native language codes of FIGS. 1 and 2; and

FIG. 4 is comprised of FIGS. 4A and 4B, and represents a process flow chart illustrating the operation of system for concurrent usage and replacement of non-native language codes of the previous figures.

### DETAILED DESCRIPTION OF PREFERRED EMBODIMENTS

The following definitions and explanations provide background information pertaining to the technical field of the present invention, and are intended to facilitate the understanding of the present invention without limiting its scope:

Address Space: Actual memory used by a running program. It may refer to physical memory (RAM chips), virtual memory (disk), or a combination of both.

Assembly Language: A programming language that is once removed from a computer's machine language. The assembly language has the same structure and set of commands as a machine language, but it enables a programmer to use names instead of numbers.

C language: A high-level programming language capable of manipulating the computer at a low level similar to assembly language.

Internet: A collection of interconnected public and private computer networks that are linked together with routers by a set of standards protocols to form a global, distributed network.

Thread: A part of a program that can execute independently of other parts.

UDF: User Defined Function. A routine that has been defined or programmed by the user of the system and has been included in a standard library of functions. In these cases, “user” typically means programmer, not end user.

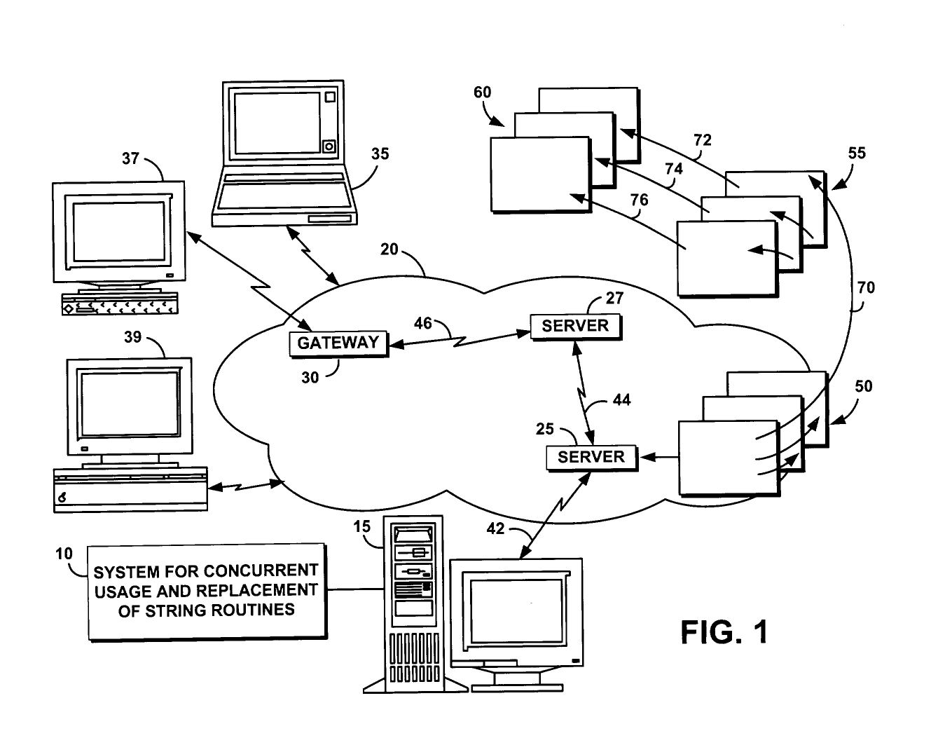

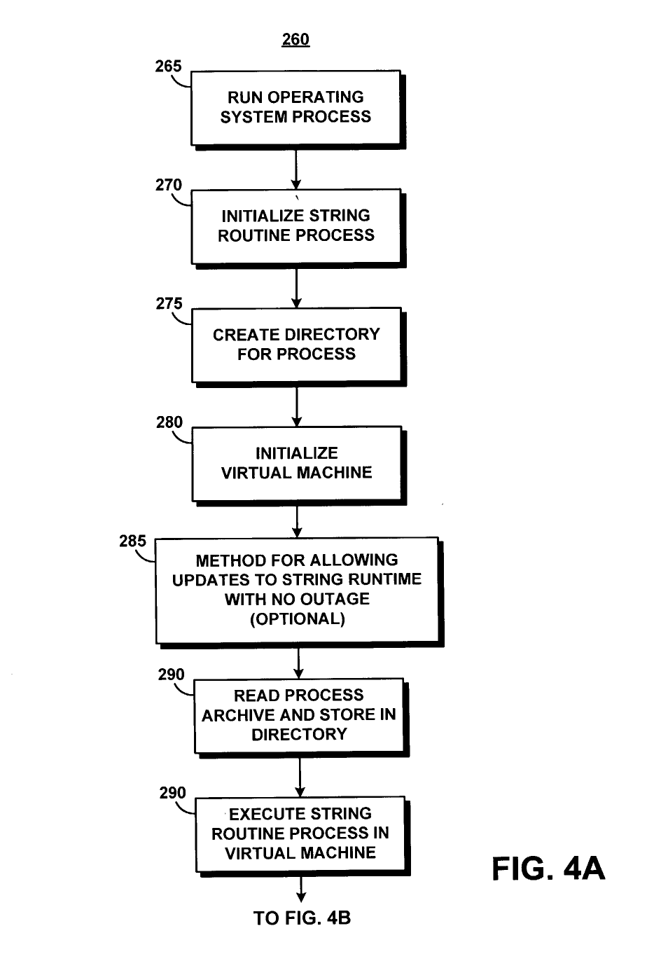

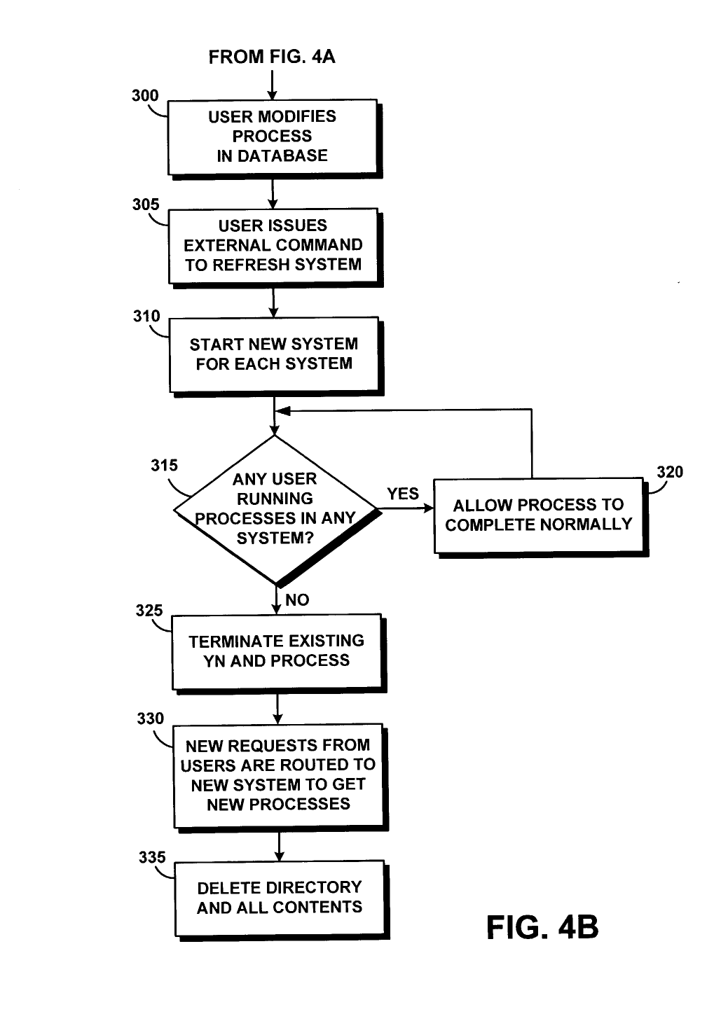

FIG. 1 portrays an overall environment in which a system 10 that provides concurrent usage and replacement of non-native language codes or associated method 260 (FIG. 4) of the present invention may be used. System 10 includes a software programming code or computer program product that is typically embedded within, or installed on a host server 15. Alternatively, system 10 can be saved on a suitable storage medium such as a diskette, a CD, a hard drive, or like devices. While the system 10 will be described in connection with the WWW, the system 10 can be used with a stand-alone database of terms that may have been derived from the WWW and/or other sources.

The cloud-like communication network 20 is comprised of communication lines and switches connecting servers such as servers 25, 27, to gateways such as gateway 30. The servers 25, 27 and the gateway 30 provide the communication access to the WWW Internet. Users, such as remote Internet users, are represented by a variety of computers such as computers 35, 37, 39, and can query the host server 15 for desired information through the communication network 20.

The host server 15 is connected to the network 20 via a communications link 42 such as a telephone, cable, or satellite link. The servers 25, 27 can be connected via high-speed Internet network lines 44, 46 to other computers and gateways. The servers 25, 27 provide access to stored information such as hypertext or web documents indicated generally at 50, 55, and 60. The hypertext documents 50, 55, 60 most likely include embedded hypertext link to other locally stored pages, and hypertext links 70, 72, 74, 76 to other webs sites or documents 55, 60 that are stored by various web servers such as the server 27.

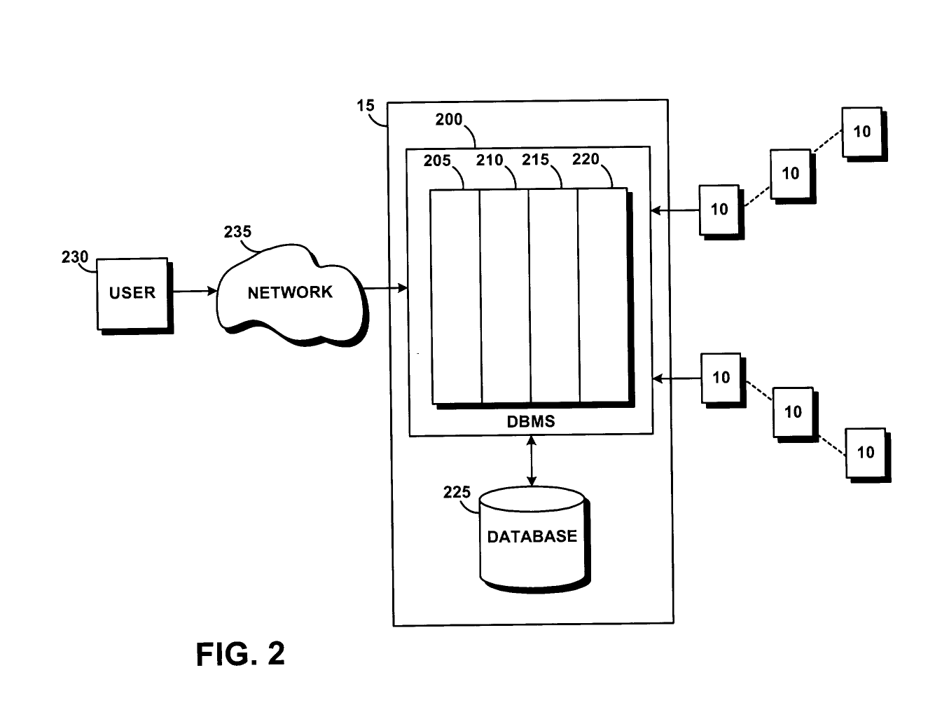

The relationship between system 10 and a DBMS 200 is shown in FIG. 2. The DBMS 200 is typically embedded within, or installed on the host server 15. The DBMS 200 is a relational database with several related and linked files 205, 210, 215, and 220 whose executable code is stored in a database 225.

A user 230 accesses the DBMS 200 through a network 235. The network 235 can be comprised of the Internet, a local area network, or any other form of interconnection between computers. Multiple non-native languages 10 can be accessed by the DBMS 200 or invoked by the user 230.

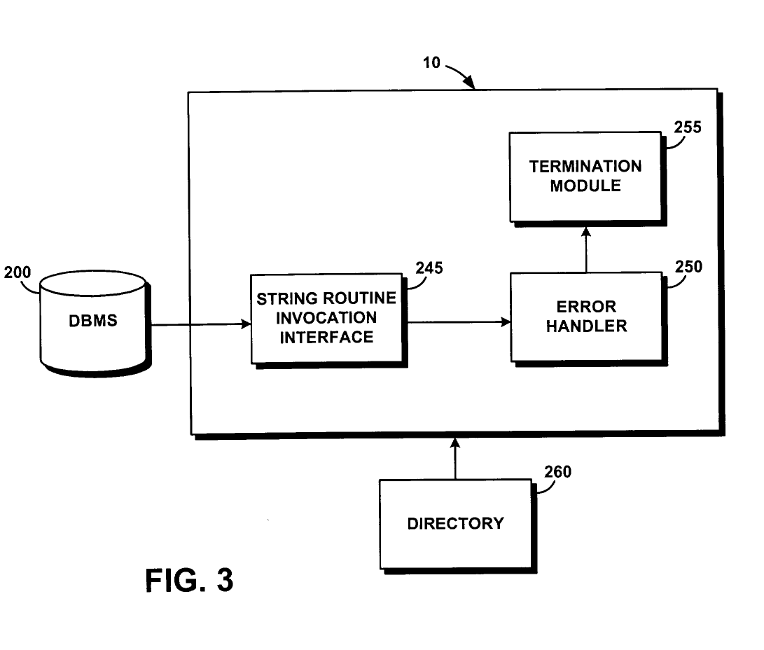

In operation, and with further reference to FIG. 3, system 10 is generally comprised of a non-native language invocation interface 245, an error handler 250, a termination module 255, and a directory 260. The invocation interface 245 is used to create the execute routines in the virtual machine.

With further reference to method 260 of FIG. 4, the operation system process is started either manually or on demand, in step 265, to run procedures server address space stored in the DBMS 200 (FIG. 3) and/or user-defined functions (UDFs). Each address space starts a configurable number of tasks (or threads).

In step 270, a virtual machine is created inside the operating system. During this step, and inside each task, the non-native language invocation interface 245 initializes a common language routine using an assembly language “shell” program, to run a desired assembly language (i.e., C language) and non-native language programs. Using the assembly language for the shell is an important aspect of system 10 because it allows the shell to be completely independent from the non-native language and assembly language runtime.

When the address space has been configured in step 270 to run normative languages, the assembly language program then creates, in step 275, a directory for the non-native language executables. Each process has its own directory. The user ID associated with the process is the only user ID that has access to the directory.

The directory name is composed of a three-level hierarchy. The first level of the hierarchy is the application environment name associated with the routine to be invoked. The second level is the database system name. The database system name is required since more than one database system can have access to the same file system. The third level of the directory name is a unique system timestamp, translated to characters.

The assembly language program in step 280 invokes a launcher application, such as a C program inside the language runtime that brings up a virtual machine and then returns to the assembly language shell. The assembly language shell then operates in step 285 as described in copending U.S. application Ser. No. ______, titled “System And Method For Allowing Updates To Non-Native Language Routine Codes With No Outage,” supra.

In step 290, system 10 reads the archive file for the non-native language process to the directory, associating it with the unique user ID. Then, in step 295, the database management system executes the non-native language process as necessary in the virtual machine.

At some time, the user may wish to update or modify the non-native language process stored in the directory. The user then, in step 300, modifies the non-native language process in the database. In order to update the archive file stored in the directory, the user issues, in step 305 an external command to refresh all the systems 10 that are currently running.

The external command to refresh causes system 10 to duplicate every environment running, in step 310. In step 315, system 10 concurrently checks all the systems 10 to determine if any user is executing any process on any of the systems 10. If so, each process is allowed, in step 320, to complete normally while the current system 10 postpones the initialization of any new executables.

When all process activity has cleared in step 315, system 10 proceeds to step 325 and terminates the existing virtual machine and process. Any new requests from the user are routed to a new system 10 in step 330 to create a new process and a new directory. In step 335, system 10 deletes the old directory and all of its contents. Directories for other executables are maintained because system 10 had already copied them to the new directory in step 310.

It is to be understood that the specific embodiments of the invention that have been described are merely illustrative of certain application of the principle of the present invention. Numerous modifications may be made to the system for a unique, protected directory to provide concurrent usage and replacement of non-native language codes described herein without departing from the spirit and scope of the present invention.

What is claimed is:

1. A method for storing a non-native language executable code in a database catalog, comprising:
creating an exclusive directory with a directory name upon initialization of a non-native language code comprising:
an application environment name associated with the non-native language code;
a database system name; and
a unique time stamp;
creating a user identification associated with the directory name; and
reading a file name of the executable code to the exclusive directory when the non-native language code is invoked, to create a file within the exclusive directory.

2. The method of claim 1, wherein the user identification allows exclusive access to the file in the exclusive directory.

3. The method of claim 1, further comprising deleting the exclusive directory and its content upon termination of the non-native language code.

4. The method of claim 1, wherein if the non-native language code is changed in the exclusive directory, triggering a new address space to be started to operate on any new task.

5. The method of claim 1, further comprising starting an operating system process prior to creating the exclusive directory.

6. The method of claim 5, further comprising creating a virtual machine inside the operating system process.

7. The method of claim 6, further comprising initializing a common language routine inside each task, using an assembly language shell program to run an assembly language and the non-native language code.

8. The method of claim 7 wherein using the assembly language shell program allows the shell program to be completely independent from the normative language code and assembly language runtime.

9. The method of claim 8, wherein the assembly language shell program invokes a launcher application inside a language runtime to initialize the virtual machine.

10. The method of claim 1, wherein if the non-native language code is changed in the exclusive directory, issuing an external command to refresh every running environment.

11. The method of claim 10, wherein the external command to refresh duplicates every running environment.

12. The method of claim 11, further comprising concurrently checking if a user is executing a task if any task in an address space is being used to process a user request.

13. The method of claim 12, wherein if a user is executing a task, allowing the task to complete normally.

14. A computer program product having instruction codes for storing a normative language executable code in a database catalog, comprising:
first set of instruction codes for creating an exclusive directory with a directory name upon initialization of a non-native language code comprising:
an application environment name associated with the non-native language code;
a database system name; and
a unique time stamp;
a second set of instruction codes for creating a user identification associated with the directory name; and
a third set of instruction codes for reading a file name of the executable code to the exclusive directory when the non-native language code is invoked, to create a file within the exclusive directory.

15. The computer program product of claim 14, wherein the user identification allows exclusive access to the file in the exclusive directory.

16. The computer program product of claim 14, further comprising a fourth set of instruction codes for deleting the exclusive directory and its content upon termination of the non-native language code.

17. The computer program product of claim 14, further comprising a fifth set of instruction codes for triggering a new address space to be started to operate on any new task if the non-native language code is changed in the exclusive directory.

18. The computer program product of claim 17, further comprising a sixth set of instruction codes for starting an operating system process prior to creating the exclusive directory.

19. The computer program product of claim 18, further comprising a seventh set of instruction codes for creating a virtual machine inside the operating system process.

20. The computer program product of claim 19, wherein the seventh set of instruction codes initializes a common language routine inside each task, using an assembly language shell program to run an assembly language and the non-native language code.

21. The computer program product of claim 20 wherein the seventh set of instruction codes allows the shell program to be completely independent from the non-native language code and assembly language runtime.

22. The computer program product of claim 21, wherein the seventh set of instruction codes invokes a launcher application inside a language runtime to initialize the virtual machine.

23. The computer program product of claim 22, wherein if the non-native language code is changed in the exclusive directory, the fifth set of instruction codes issues an external command to refresh every running environment.

24. The computer program product of claim 23, wherein the external command to refresh duplicates every running environment.

25. The computer program product of claim 24, wherein the fifth set of instruction codes concurrently checks if any task in the address space is executing work for a user request; and
wherein if a user is executing a task, the fifth set of instruction codes allows the task to complete normally, and further allows another address space to operate on any new task.

26. A system for storing a non-native language executable code in a database catalog, comprising:
means for creating an exclusive directory with a directory name upon initialization of a non-native language code comprising:
an application environment name associated with the non-native language code;
a database name; and
a unique system time stamp;
means for creating a user identification associated with the directory name; and
means for reading a file name of the executable code to the exclusive directory when the non-native language code is invoked, to create a file within the exclusive directory.

27. The system of claim 26, wherein the user identification allows exclusive access to the file in the exclusive directory.

28. The system of claim 26, further comprising means for deleting the exclusive directory and its content upon termination of the non-native language code.

29. The system of claim 26, further comprising means for triggering a new address space to be started to operate on any new task if the non-native language code is changed in the exclusive directory.

30. The system of claim 29, further comprising means for starting an operating system process prior to creating the exclusive directory.

31. The system of claim 30, further comprising means for creating a virtual machine inside the operating system process.

32. The system of claim 31, wherein the means for creating the virtual machine initializes a common language routine inside each task, using an assembly language shell program to run an assembly language and the non-native language code.

33. The system of claim 32, wherein the means for creating the virtual machine allows the shell program to be completely independent from the normative language code and assembly language runtime.

34. The system of claim 33, wherein the means for creating the virtual machine invokes a launcher application inside a language runtime to initialize the virtual machine.

35. The system of claim 34, wherein if the non-native language code is changed in the exclusive directory, the triggering means issues an external command to refresh every running environment.

36. The system of claim 35, wherein the external command to refresh duplicates every running environment.

37. The system of claim 36, wherein the triggering means concurrently checks if any task in the address space is executing work for a user request; and
wherein if a user is executing a task, the fifth set of instruction codes allows the task to complete normally, and further allows another address space to operate on any new task.
